(19) United States
(12) Patent Application Publication
(10) Pub. No.: US 2009/0321040 A1
(43) Pub. Date: Dec. 31, 2009

(54) METHODS AND SYSTEMS FOR HOLE RECLAMATION FOR POWER GENERATION VIA GEO-SATURATION OF SECONDARY WORKING FLUIDS

(76) Inventor: Joshua J. Poitras, Griswold, CT (US)

Correspondence Address: NIXON PEABODY, LLP, 300 S. Riverside Plaza, 16th Floor, CHICAGO, IL, 60606, US

(21) Appl. No.: 12/492,593

(22) Filed: Jun. 26, 2009

Related U.S. Application Data
(60) Provisional application No. 61/076,108, filed on Jun. 26, 2008.

(51) Int. Cl. F24J 3/08; F03G 7/00

(52) U.S. Cl. 165/45; 60/641.3

(57) ABSTRACT

This invention relates to systems and methods for using a hole to generate power via geo-saturation of secondary working fluids. One system includes a plurality of conduits/tubulars/exchangers, a thermal hydraulic engine, power generation equipment, organic compound secondary working fluid, thermally conditioned fill material, a condenser, a cooling apparatus, and a fluid pump.

### RELATED APPLICATION

This application claims the benefit of U.S. Provisional Patent Application No. 61/076,108 filed on Jun. 26, 2008, the contents of which are entirely incorporated herein by reference.

### BACKGROUND OF THE INVENTION

1. Field of the Invention

The present invention relates generally to a methods and systems for hole reclamation, and more specifically, to methods and systems for reclaiming non-viable earth commodity holes or of using specifically drilled holes to access the earth's heat for power generation via geothermal heating of secondary working fluids, which are utilized in thermal hydraulic engines and power generation equipment.

2. Description of Related Art

It can be appreciated that methods of hole reclamation have been in use for years. Typically, methods of hole reclamation for space heating and cooling include the use of heat pumps on short, small diameter holes with back fill material and apparatuses. Other methods use the extraction of geothermal brines for use as a heat transfer fluid for top of hole equipment. The extraction of geothermal brines for use as a heat transfer fluid requires two or more holes, with at least one used to inject/reinject the fluid and the other to extract the fluid. The extraction also requires resource development and monitoring. Other methods of reclamation include injection drilling muds, bentonite, neat cement, sand or other flowable fills or some combination thereof to refill the hole annulus. Currently in the mining and earth commodity exploration industry, non-viable exploration and/or monitoring holes are back-filled with concrete, bentonite, sand, neat cement, or some combination thereof. Additionally, such holes may be merely covered or left as open holes in order to avoid further financial losses and cost associated with re-filling a hole with no foreseeable commercial use.

Heat pumps are typically used in specifically designed shallow depth low temperature systems. Generally, in climates where heating and cooling are most required, the ground temperatures at shallow, generally affordably reached depths, do not afford substantial capacity for generating work via thermal hydraulic equipment or similar thermodynamic cycles. As a result, the holes typically used for heat pumps only allow for applications in space heating and cooling as they lack the capacity necessary to generate substantial work. Thus, the ability to generate an output of work, such as via a turning shaft that could be used to generate useful electrical power, is not viable with conventional heat pump systems or combinations thereof. Conventionally available heat pump equipment is not readily designed for deep hole applications or for use at significant distances from occupied structures. As a result they do not offer a commercially exploitable means for the recovery of financial losses incurred when exploration or monitoring holes are deemed undevelopable.

Furthermore, systems that utilize the extraction of geothermal brines as a heat transfer fluid require the use of two or more drilled holes relatively proximate to each other and resources for extracting and injecting the liquids. Such systems include substantial inherent cost barriers associated with developing the resource (the hole), constant monitoring, and extreme subterranean variables, all of which make it difficult and expensive to develop a location utilizing such methods. Additionally such systems are not closed systems in the sense that the geothermal brines are continuously reinjected into the earth in a way that could be damaging to water supplies or otherwise environmentally harmful.

Reusing existing holes utilizing conventional methods of space heating and cooling or power generation via extraction and injection of geothermal brines is typically not economically viable. These holes are generally either much too deep or too remote from an occupied structure or point of demand to allow them to be reused for space heating and cooling in an economically viable manner, particularly given the low commercial value of space heating and cooling of an occupied structure. Additionally, conventional methods to extract and inject geothermal brines for use as a heat transfer fluid require higher assumed financial risks to develop resources and infrastructure.

Additionally, conventional methods of hole reclamation incur costs associated with abandonment or filling non-viable holes. Many completed holes are not commercially feasible to fully develop due to changes in the commercial conditions that facilitated their original development. Hence, the remaining hole must either be filled with suitable filling materials or capped, which creates significant losses for responsible parties. Another problem with conventional methods of hole reclamation is the use of inexpensive fill materials such as bentonite clays, sands, and neat cements that have been proved to fail under normal field conditions. These materials readily sacrifice system efficiencies and lead to aquifer contamination by either debonding from earth loop transfer equipment, cracking, or shrinking. Even though common fill materials are readily available and affordable, they are not feasible for long-term efficiency or for environmental protection.

### SUMMARY OF THE INVENTION

While the above described methods may be suitable for the particular purposes they are addressed to, they are not particularly suitable for reclaiming non-viable earth commodity holes, post-production oil and gas holes, specifically drilled holes, or stand-alone onshore or offshore wells to access the earth's heat for power generation via geothermal heating of secondary working fluids utilized in a thermal hydraulic engine and generation equipment or otherwise.

In view of the foregoing disadvantages in conventional methods of hole reclamation, the methods and systems for power generation via geo-saturation of secondary working fluid according to aspects of the present invention substantially departs from conventional concepts and designs, and in so doing provides an apparatus primarily developed for the purpose of reclaiming non-viable earth commodity holes or specifically drilled holes to tap into the earths heat for power generation via the geologically facilitated saturation of secondary working fluids utilized in the thermal hydraulic equipment and power generation equipment.

Accordingly, embodiments of the methods and systems can be utilized for reclaiming non-viable earth commodity holes, post-production oil and gas holes, exploration holes, specifically drilled holes, or onshore or offshore stand-alone wells to tap into the earth's heat for power generation via geothermally facilitated critical temperature saturation of secondary working fluids which are then utilized in thermal hydraulic equipment and power generation equipment.

One example embodiment of the present invention generally includes a commercially non-viable earth commodity hole or specifically drilled hole at a depth with adequate subterranean temperatures, thermally conditioned backfill materials, organic compound secondary working fluids, down hole flexible or rigid conduit, a pump for movement of organic compound secondary working fluids to and from the down hole conduits and the thermodynamic cycle of thermal hydraulic engines, and power generation equipment. It should further be understood by one skilled in the art that while conduits are referred to above and elsewhere in this description, the underground apparatus includes a combination that may include conduits, tubulars, pipes, exchangers, or a combination of them. The commercially non-viable hole may be an exploration hole, a post production commodity hole, a specially drilled hole, or an either onshore or offshore hole so long as the hole has viable subterranean temperatures at a plurality of depths. The hole which may vary in depth from 100-30,000 feet or greater and 4 inches to 36 inches in diameter or greater. Further, the hole may have a plurality of diameters along its construction and may be either cased or uncased. A thermal hydraulic engine apparatus is located at the upper portion of the hole and is in fluid connection on one end to the down hole conduits and connected on the output end to power generation equipment via means necessary to transfer work into electrical energy, such as could be accomplished with a rotating shaft.

In an example embodiment, the organic compound secondary working fluid has a low critical temperature, preferably greater than 60° F. in the liquid phase. When heated above its critical temperature, the secondary working fluid undergoes a phase transition and is in its supercritical temperature region. The secondary working fluid operates the thermal hydraulic engine process via its expander apparatus, satisfying the expansion phase of the returning saturated secondary working fluid from down hole conduits. Thermally-conditioned fill material, such as pumpable cementitious and/or pozzolanic grout, or some combination thereof, provides low thermal resistance between the hole wall and the conduits in the lower portion of the hole in order to facilitate efficient heat transfer to the secondary working fluid contained within the conduits. In one embodiment the thermally conditioned fill material also provides for adequate zonal isolation across and along the hole's length and width. A conduit extending from the upper portion of the hole to the lower portion of the hole is connected to the pump. The conduits may be constructed from a plurality of material types, diameters, lengths, and configurations suitable for subterranean conditions and operating designs. Furthermore, even where not already specified the conduits may be flexible or rigid or a combination thereof. Secondary working fluid conduits are contained in a larger vessel, such as a condenser, in which cooling fluid from the cooling tower condenses secondary working fluid back to subcritical temperatures. A conventional suitable cooling apparatus is used to cool heated cooling fluid. The electrical generator is powered by the thermal hydraulic engine with an output capacity of a plurality of electrical kilowatts. To install the system, conventional equipment is used for spooling a plurality of pipes down holes. Conventional cementing equipment may be used for cementing or may be used in combination with other spooling and cabling equipment utilized in a novel way as will be understood by those skilled in the art. A fluid pump is used to move secondary working fluids to and from down hole conduits and from the condenser and the thermal hydraulic engine apparatus.

In operation, the secondary working fluid is pumped through a tube into a hole underground where it undergoes a phase transition from liquid to gas in response to the increased subterranean temperature. Following the phase transition, the volume of the fluid increases, which increases the pressure of the resulting gas vapor. The pressurized gas vapor then escapes through a second tube in the same hole to eventually drive a thermal hydraulic engine which drives a generator to generate electricity. In one embodiment the thermal hydraulic engine may be realized as a gas driven turbine. The secondary fluid is then transported through pipes to be cooled via a condenser that radiates heat away from the system using a cooling tower thermally coupled to the condenser via a cooling fluid. Both the secondary working fluid and the cooling fluid are each contained in separate closed systems. The condensed and cooled secondary working fluid is then pumped back down the hole through the original tube and the cycle begins again.

Here geo-saturation refers to utilizing geothermal heat energy to bring the secondary working fluid to its critical temperature without allowing its saturation point where it cannot hold any additional energy without undergoing a phase transition. As used herein, a geothermally saturated, or geo-saturated, secondary working fluid, as well as appropriate grammatical variations thereof, is used to describe a secondary working fluid that has reached its critical temperature at a given pressure, but has not changed its state through a phase transition.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An aspect of embodiments of the present invention is to provide methods and systems for power generation via geo-saturation of a secondary working fluid that will overcome the shortcomings of conventional devices and methods.

Another aspect of embodiments of the present invention is to provide methods and systems for power generation via geo-saturation of a secondary working fluid for reclaiming non-viable earth commodity holes, post-production oil and gas holes, or specifically drilled holes, with the intention of accessing the earth's heat for power generation via geothermal saturation of secondary working fluids utilized in thermal hydraulic engines and power generation equipment.

Another aspect of embodiments of the present invention is to provide methods and systems for power generation via geo-saturation of a secondary working fluid that provides for a commercially exploitable means of recovering financial losses incurred when the exploration of earth commodities via hole drilling operations is no longer commercially viable or when post-production for the commodity has taken place, but also where potential power or work demand and where viable subterranean temperatures exist.

Another aspect of embodiments of the present invention is to provide methods and systems for power generation via geo-saturation of a secondary working fluid that provides for a commercially exploitable means of reclaiming subterranean geological monitoring holes or specially drilled holes where potential power or work demand and viable subterranean temperatures exist.

Another aspect of embodiments of the present invention is to provide methods and systems for power generation via geo-saturation of a secondary working fluid that provides adequate aquifer protection by utilizing thermally conditioned hole fill materials for transferring heat from the viable subterranean region to the down hole lower portion apparatus of conduits, tubulars and exchangers.

Another aspect of embodiments of the present invention is to provide methods and systems for power generation via geo-saturation of a secondary working fluid that allows for responsible exploration or production by parties, agencies, or organizations seeking for a means to fulfill hole abandonment regulations while recovering invested exploration capital.

Another aspect of embodiments of the present invention is to provide methods and systems for power generation via geo-saturation of a secondary working fluid that allows for demand that may be far enough off the existing power grid to have premium priced power, but may have readily available exploration holes to ease premium power prices given their geographic location relative to the existing power grid.

Another aspect of embodiments of the present invention is to provide methods and systems for power generation via geo-saturation of a secondary working fluid that combines the methods, principles, and technologies of heat pumps and earth installed temperature transferring conduits with thermal hydraulic equipment and non-viable earth commodity exploration, post production oil and gas holes, monitoring holes, or specially drilled holes and thermally conditioned fill materials and specially designed down hole conduits to produce an output of work via a specially designed thermal hydraulic engine for power generation.

Another aspect of embodiments of the present invention is to provide methods and systems for power generation via geo-saturation of a secondary working fluid that utilizes and combines the methods, principles and technologies of heat pumps, and earth installed temperature transferring conduits, tubulars, and exchangers, with thermal hydraulic equipment utilizing CO₂, other secondary working fluids, or other specially designed organic compounds used as secondary working fluids in a single hole with down hole conduits.

Other aspect of embodiments of the present invention and advantages of the present invention will become obvious to the reader and it is intended that these aspect and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1a illustrates an embodiment of a system for generating power via geo-saturation of a secondary working fluid utilizing a hole to transfer geothermal heat to the system.

FIG. 1b a side view cross-section of a hole showing an embodiment of a down hole apparatus of conduits, pipes, tubulars, and exchangers in place inside the hole.

FIG. 2 is a side view cross-section of a lower region of a hole having viable subterranean temperatures showing an embodiment of a down hole apparatus of conduits, pipes, tubulars, and exchangers in place inside hole.

FIG. 3 is a top view cross-section of a hole showing an embodiment of a down hole apparatus of conduits, pipes, tubulars, and exchangers in place.

FIG. 4 is a side view cross-section of a hole showing an embodiment of a down hole apparatus of conduits, pipes, tubulars, and exchangers in place inside the hole.

FIG. 5 is a side view cross-section of a lower region of a hole having viable subterranean temperatures showing an embodiment of a down hole apparatus of conduits, pipes, tubulars, and exchangers in place inside hole.

FIG. 6 illustrates an embodiment of a system for generating power via saturation of a secondary working fluid utilizing biomass or compost to transfer heat to the system.

### DETAILED DESCRIPTION

Turning now descriptively to the drawings, in which similar reference characters denote similar elements throughout the several views, the attached figures illustrate embodiments of methods and systems for power generation via geo-saturation of a secondary working fluid.

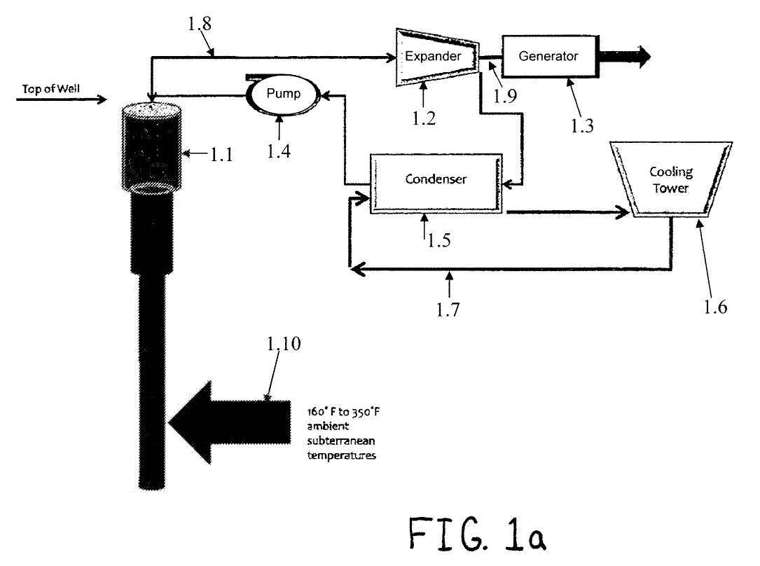

FIG. 1a illustrates an embodiment of a system for generating power via geo-saturation of a secondary working fluid utilizing a hole to transfer geothermal heat to the system. FIG. 1a includes a non-viable earth commodity hole or specifically drilled hole 1.1 with adequate subterranean temperatures, as in the geologic formation 1.10 illustrated, specially designed thermally conditioned backfill materials, specially designed down hole flexible or rigid conduits, a suitable secondary working fluid 1.8, a pump 1.4, a thermal hydraulic engine 1.2, which may be embodied as a thermal hydraulic engine, an electrical generator 1.3, a condenser 1.5, a cooling fluid 1.7, and a cooling tower 1.6. The bottom of the hole 1.1 is in fluid connection with the thermal hydraulic engine 1.2 via conduits. The thermal hydraulic engine 1.2 is further connected to the electrical generator 1.3 via a rotating shaft 1.9 or other means for transferring the heat energy extracted in the thermal hydraulic engine 1.2 to be harnessed as electrical energy in the electrical generator 1.3. The output side of the thermal hydraulic engine 1.2 is in fluid connection with a first input of the condenser 1.5 via additional conduits, which input is also in fluid connection with an input to the pump 1.4. The condenser 1.5 further includes an input and output for cooling fluid 1.7, where both the input and the output are in fluid connection with a cooling tower 1.6 or equivalent device useful for radiating away heat. The condenser 1.5 allows for the secondary working fluid 1.8 to transfer heat to the cooling fluid 1.7 thereby cooling the secondary working fluid 1.8 before it enters the pump 1.4. The output of the pump 1.4 is in fluid connection with a second down hole conduit.

In operation of a preferred embodiment of the present invention, the secondary working fluid 1.8 is pumped from a pump 1.4 through a tube into an underground hole 1.1 where it undergoes a phase transition from liquid to gas in response to increased subterranean temperature. Following the phase transition, the volume of the secondary working fluid 1.8 increases, which increases the pressure of the secondary working fluid 1.8, which is now a gas vapor. The pressurized secondary working fluid 1.8 then escapes through a second tube in the same hole 1.1 to eventually drive a thermal hydraulic engine 1.2 which drives a generator 1.3 to generate electricity. In one embodiment the thermal hydraulic engine 1.2 may be realized as a gas driven turbine or expander. The secondary fluid 1.8 is then transported through pipes to be cooled via a condenser 1.5 that radiates heat away from the system using a cooling tower 1.6 thermally coupled to the condenser via a cooling fluid 1.7. Both the secondary working fluid 1.8 and the cooling fluid 1.7 are each contained in separate closed systems that continuously recirculate. The condensed and cooled secondary working fluid 1.8 is then send back to the pump 1.4 where it is pumped back down the hole 1.1 through the original tube and the cycle begins again.

For movement of secondary working fluids to and from the down hole conduits, and a specially designed thermal hydraulic engine 1.2 and power generation equipment 1.3. It should be understood by one skilled in the art that while conduits are referred to above and elsewhere in this description, the underground apparatus includes a combination that may include conduits, tubulars, pipes, exchangers, or a combination of them. A commercially non-viable exploration hole 1.1, post-production commodity hole, or specially drilled hole has viable subterranean temperatures at a plurality of depths. The hole 1.1 may vary in depth from 100-30,000 feet or greater and 4 inches to 36 inches in diameter or greater. Further, the hole 1.1 may have a plurality of diameters along its construction and may be either cased or uncased. A thermal hydraulic engine 1.2 located at the upper portion of the hole 1.1 is connected on one end to conduits and connected on the output end to power generation equipment 1.3 via a rotating shaft 1.9. In one embodiment, the expander apparatus 1.2 may be a turbo expander or thermal hydraulic engine. In other embodiments the rotating shaft 1.9 may be replaced with any means of transferring energy extracted from the thermal hydraulic engine 1.2 to the power generation equipment 1.3. An organic compound secondary working fluid 1.8 is preferably capable of low critical temperatures greater than 60° F. in the liquid phase. When the secondary working fluid 1.8 is heated to temperatures above this point, the secondary working fluid 1.8 changes phase to a gas and is in its supercritical temperature region. This expansion further operates the thermal hydraulic engine process via its thermal hydraulic engine 1.2, which may be embodied as a turbo expander turbine.

FIG. 1b illustrates an embodiment of a system for generating power via geo-saturation of a secondary working fluid. As seen in FIG. 1b, thermally-conditioned fill material, such as pumpable cementitious and/or pozzolanic grout, or some combination thereof, may provide low thermal resistance between the hole walls and the conduits in the lower portion of the hole 1.1 in the region encompassing the relevant formation 1.10 with adequate subterranean temperatures. It also provides for adequate zonal isolation across and along the length and width of the hole 1.1. A flexible or rigid conduit/tubular/exchanger extending from the upper to the lower portion of the hole 1.1 is connected to the pump 1.4 in which the secondary working fluid flows through and acclimates to critical saturation temperatures in the lower temperature bearing portion of the hole. The apparatus utilizing conduits, pipes, tubulars, and exchangers may be constructed from a plurality of material types, diameters, lengths, and configurations suitable for subterranean conditions and operating designs. Secondary working fluid conduits are contained in a larger vessel, such as a condenser 1.5, in which cooling fluid 1.7 from the cooling tower 1.6 condenses the secondary working fluid 1.8 back to subcritical temperatures. A conventional suitable cooling apparatus may be used to cool heated cooling fluid 1.7. The electrical generator 1.3 is powered by the thermal hydraulic engine 1.2 with an output capacity of a plurality of electrical kilowatts. A fluid pump 1.4 is used to move secondary working fluid 1.8 to and from down hole conduits/tubulars/exchangers and from the condenser 1.5 and the thermal hydraulic engine 1.2.

A commercially non-viable exploration hole, post production commodity hole, or specially drilled hole of which has viable subterranean temperatures at any depth and any diameter along its construction may be cased or uncased. Hole 1.1, as shown in FIG. 1a, is a hole made in subterranean formations via drilling downward into the earth's crust for the exploration of commercially viable commodities, such as usable minerals, fluids, resource monitoring, or is specifically drilled to be used to extract the earth's heat geothermally. Drilling of hole 1.1 may be done in a plurality of diameters to a plurality of depths into the formations in the earth's crust that could potentially contain the sought after resource results in a constructed hole either cased or uncased. Furthermore, given that not all exploration holes are successful at locating commercially exploitable commodities and that production holes are not infinitely productive, there remains open hole 1.1 and the loss of invested capital that is or was necessary to drill, fill, cap and reclaim the hole once its intended purpose has been fully exercised. Hole 1.1 could be drilled for the exploration of earth commodities in a plurality of depths and a plurality of diameters. Hole 1.1 may also be drilled in a plurality of depths and a plurality of diameters for the removal of commercially exploitable commodities fluids or otherwise that have been fully depleted. Hole 1.1 may also be drilled in a plurality of depths and a plurality of diameters in order to monitor and gather geological resource or environmental data observations which are no longer useful to the responsible parties. Also, hole 1.1 may be drilled for the extraction or injection of geothermal brines, gasses, or other organic compounds or substances at a plurality of depths and a plurality of diameters.

A thermal hydraulic engine with an expander/machinery apparatus located at the upper portion of the hole is connected on one end to the conduit tubulars/exchanger and connected on the output end to the power generation equipment. Thermal hydraulic engine 1.2, as shown in FIG. 1a, utilizes thermodynamics to apply rotational torque via the expansion phase of supercritical secondary working fluid 1.8 in the expander portion of thermal hydraulic engine 1.2 joined by output shaft 1.9 to power generator apparatus 1.3. Thermal hydraulic engine 1.2 must adequately facilitate the expansion phase at multiple pressures and multiple mass flow rates of the input of secondary working fluid 1.8 and be either oil or oil-less bearing or airfoil bearing. Thermal hydraulic engine 1.2 may utilize a plurality of organic secondary working fluids 1.8 for the production of supercritical secondary working fluids to expand in an expander specifically designed to endure working modes of operation encountered in said environments. Preferably, thermal hydraulic engine 1.2 will be connected via turning shaft 1.9 to electrical generator apparatus 1.3 to satisfy any demand local, domestic or off-shore. It may employ a plurality of heat sources, such as waste heat of any suitable source, such as geothermal heat from a geologic formation 1.10 or photovalic heat, which employs a plurality of secondary working fluids 1.8 suitable for supercritical saturation in the conduits/tubulars/exchangers to and from a plurality of heat sources. Thermal hydraulic engine 1.2 itself may be employed to perform any demanded output of work such as could be utilized with turning shaft 1.9 for the electrical power generation for satisfying pumping requirements of producing resource holes.

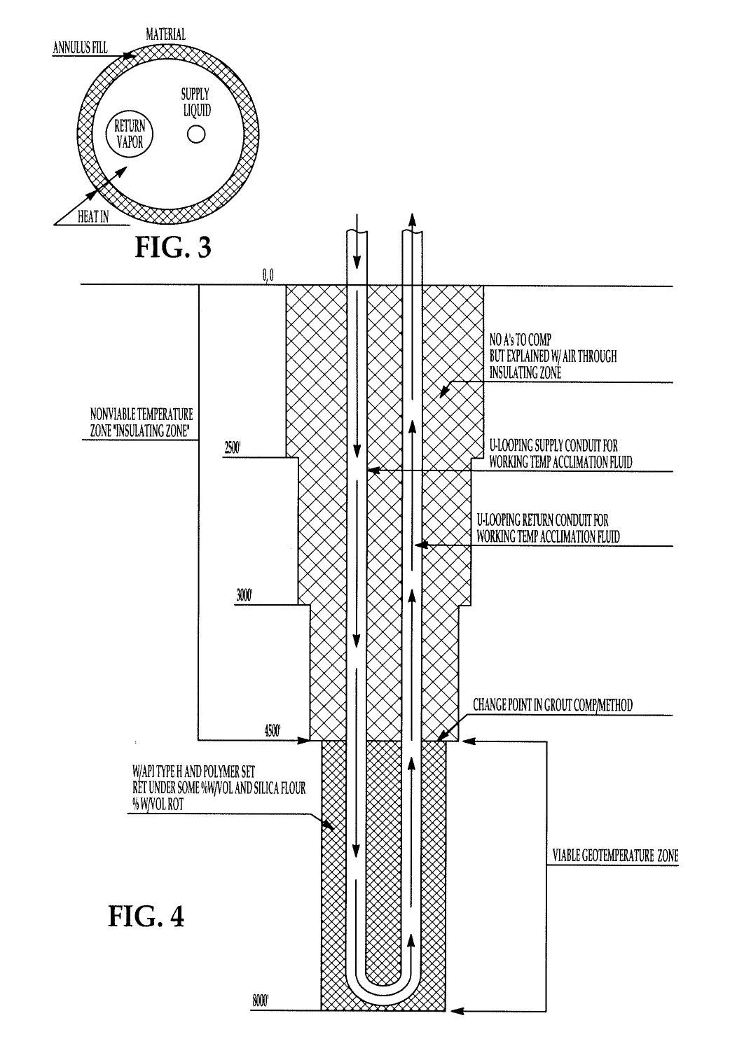

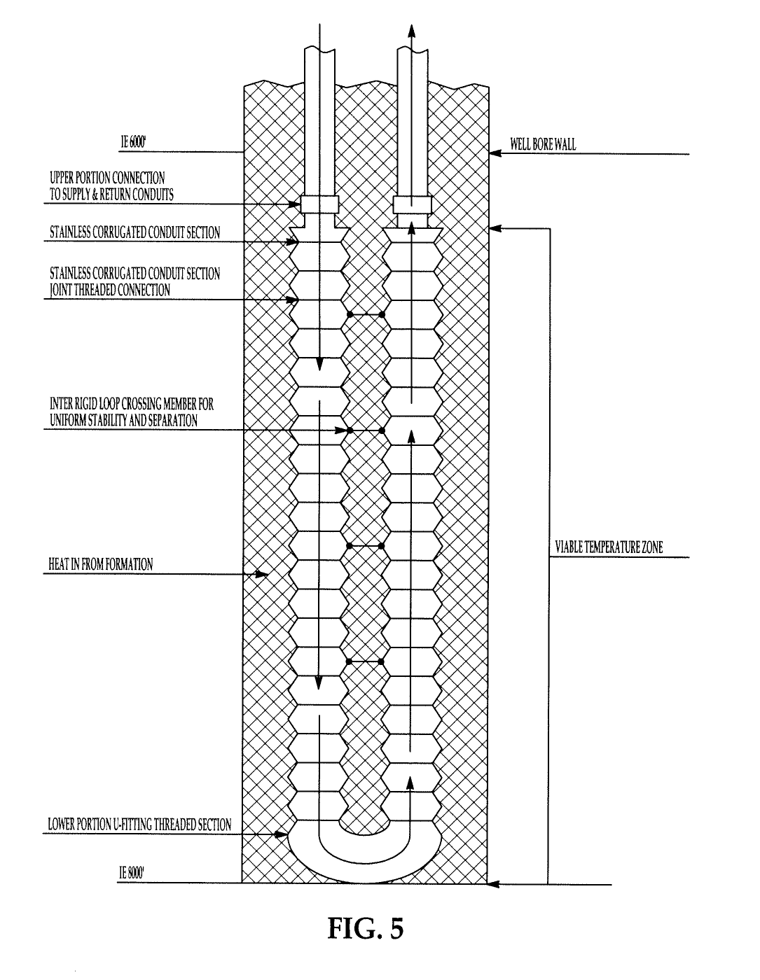

Organic compounds capable of low critical temperatures greater than 60° F. in the liquid phase, when heated, are in their supercritical temperature region and further operate the thermal hydraulic engine process via the thermal hydraulic engine 1.2, which may be embodied as an expander, satisfying the expansion phase of the returning saturated secondary working fluid 1.8 from down hole tubulars/exchanger. Secondary working fluid 1.8 of FIGS. 1-5 should be a suitable organic compound common or specially designed refrigerant that will be environmentally friendly, economically feasible, and human safe while satisfying the demands of the preferred embodiments of the present invention inside the parameters of each use specific to the variables of each specific location, hole, slab, or method employed. Working fluid 1.8 preferably has a critical temperature of 60° F. or higher and a critical pressure of 100 psia or higher. Secondary working fluid 1.8 should exhibit no corrosive reaction to conduits/tubulars/exchangers, as shown in FIGS. 1-5. Secondary working fluid 1.8 should work in a nondestructive and noncorrosive manner with thermal hydraulic engine 1.2 and condenser 1.5. Secondary working fluid 1.8 should also be able to be compressed to a liquefied gas in conduits/tubulars/exchangers in a specific plurality of applications, such as heat harvesting slab construction or hole applications.

Thermally conditioned fill material, such as pumpable cementitious and/or pozzolanic grout or some combination thereof, provides low thermal resistance from hole wall to conduit/tubulars/exchanger in the lower portion of hole 1.1, as well as provide for adequate zonal isolation across and along the hole's length and width. The thermally conditioned fill material should have a thermal conductivity rating of at least 1 btu/hr/ft/° F. but preferably greater than 1.4 btu/hr/ft/° F. It should have a coefficient of permeability of at least 1.0×10(−10) cm/s but preferably 1.6×10(−10) cm/s or greater. It should have a bond strength to flexible or rigid composite conduits/tubulars/exchangers of at least (100+/−20.5) kPa but preferably (150+/−20.5) kPa or greater. It should have a 28 day compressive strength of at least (10+/−4.2) MPa, but preferably greater than (30+/−4.2) MPa. The thermally conditioned fill material should form a pumpable slurry, having a composition of at least those listed in U.S. Pat. No. 6,251,179. With pozzolanic grout, mixtures of a plurality of %/wt ratios may be added. Such add mixtures, in combination with the composition described in U.S. Pat. No. 6,251,179, have pozzolanic qualities that could be any combination of Class C Flyash, Alkali Activated Slags, surfactants, retarders, sulfate resistant Portland Cement, silica fume, and/or an alumina oxide grit ground to at least a 4000 Blane finess, in some relative plurality of proportions of water-cement ratios and percent by weight.

Flexible and/or rigid conduits/tubulars/exchangers extending from the upper to lower portion of the hole 1.1 is connected to the upper portion pump 1.4, in which the secondary working fluid 1.8 flows through and acclimates to critical saturation temperatures in the lower, temperature bearing portion of hole 1.1. The conduits/tubulars/exchangers may be constructed in a plurality of material types, diameters, lengths, and configurations suitable for subterranean conditions and operating designs. The conduit/tubulars/exchangers should be of suitable diameter composite, integrity, conductivity or otherwise. They must also have either flexible or rigid properties as to accommodate the specified hole diameters, depths and specified thermal hydraulic engine requirements of flow. They should have a lower portion joined to an upper portion with a continuous interior opening, such as a u-joint, thus allowing for continuous flow of secondary working fluid 1.8 to and from pump 1.4, as shown in FIG. 1a. The conduit/tubulars/exchanger should extend from pump 1.4, located at the upper portion of hole 1.1, to where a suitable connection is made extending down to the lower portion of hole 1.1, while a continuous opening is maintained through the conduit/tubulars/exchanger and returning up and extending from the lower portion of hole 1.1 to the upper portion of hole 1.1, and interfacing with the thermal hydraulic engine 1.2. The conduit/tubulars/exchanger could take a plurality of forms being of any suitable composite material that can function in temperatures of 100° F. to 600° F. and handle working pressures of 1 psia or greater, but preferably 1000 psia or greater. It could extend down any hole of any diameter and depth, given subterranean temperatures exist above 60° F. Furthermore, the conduit/tubulars/exchanger could lay embedded in any configuration in any cementitious material constructed slab with the intention of exchanging heat from commercial waste heat or composting operations.

Secondary working fluid conduits are contained in a larger vessel in which cooling fluid 1.7 from the cooling tower 1.6 condenses secondary working fluid 1.8 back to subcritical temperatures. Condenser 1.5, as shown in FIG. 1a, should take the form of a vessel in which cooling fluid 1.7 flows through openly and freely while coming in contact, on the interior of condenser 1.5, in a conventional configuration, with conduits carrying secondary working fluid 1.8. Condensor 1.5 could take the form of any apparatus designed to bring secondary working fluid 1.8 back into its sub-critical condensed state.

Conventional suitable cooling apparatus used to cool heated cooling fluid. Cooling tower 1.6 as shown in FIG. 1a could be of any material and design necessary to facilitate the heat rejection of the coolant as it returns from condenser 1.5. Cooling tower 1.6 could take the form and function of a surface body of water with a necessary and adequate configuration of conduits carrying cooling fluid 1.7, submerged as to accommodate an exchange of heat from cooling fluid 1.7 to the body of water.

The electrical generator 1.3 is powered by a thermal hydraulic engine 1.2 with an output capacity of a plurality of electrical kilowatts. The electrical generator 1.3, as shown in FIG. 1a, may be conventional equipment, yet be compatible with and interfaced to thermal hydraulic engine 1.2. The electrical generator 1.3 should have a net kW output of at least 1 kW, but preferably greater than 200 kW. Power generation equipment 1.3 could take the form of any apparatus powered by a turning shaft 1.9 with a useable output of work, such as pumping equipment or handling equipment.

In constructing the system illustrated in FIGS. 1-5, conventional equipment may be necessary for spooling a plurality of pipes down holes and conventional cementing equipment may be necessary for cementing, spooling and cabling equipment in a novel way. The novel combination of spooling and cabling conduits/tubulars/exchangers, as shown in FIGS. 1-5, should be downward to the lower portion of hole 1.1. Spooling, cabling, and fusing lengths of specified conduit/tubulars/exchanger should be done simultaneously downward until the lowest required depth in hole 1.1 is met. A third conduit is temporarily lowered into hole 1.1 simultaneously with the secondary working fluid conduit/tubulars/exchanger. The third conduit carries the pumped thermally conditioned backfill material, as shown in FIGS. 1-5. The spooling and cementing equipment could also utilize conventional methods associated with installing conduits/tubulars/exchanger into cementitious horizontal slabs or vertical walls associated with a heat source that could be economically harvested such as via the systems and methods which are described as embodiments of the present invention, which bring secondary working fluids at or above specified critical temperatures in conduit/tubulars/exchangers to facilitate the thermal hydraulic engine 1.2 expander via the expansion phase of a critical temperature organic secondary working fluid 1.8, as shown in FIGS. 1-5.

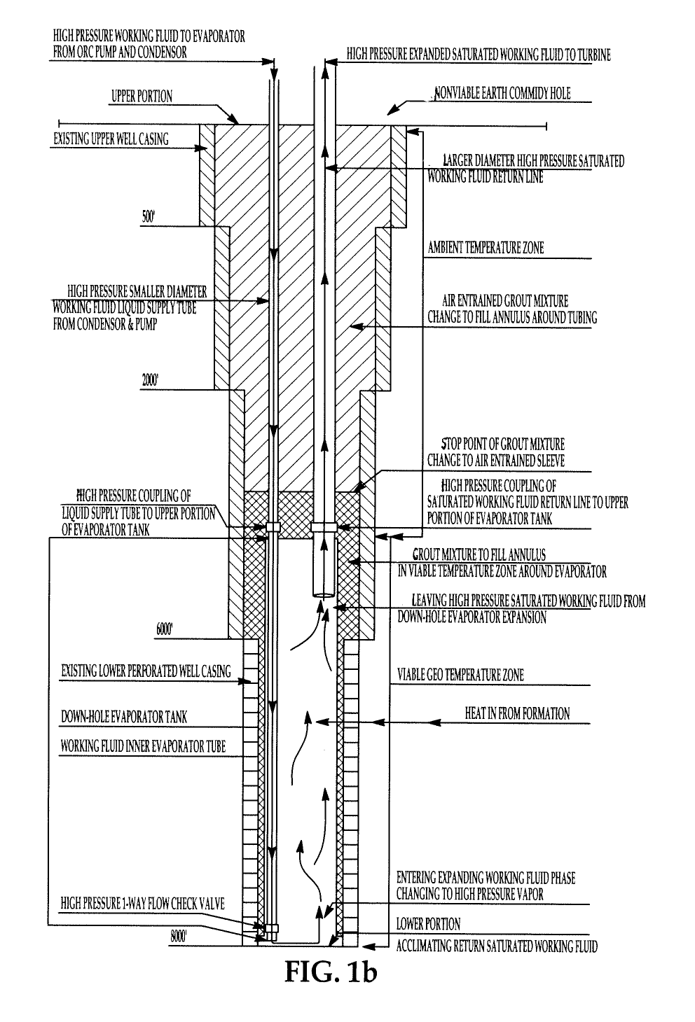

A fluid pump 1.4 may be used for moving secondary working fluids to and from down hole conduits/tubulars/exchangers and to and from the condenser 1.5 and the thermal hydraulic engine 1.2. Secondary working fluid pump 1.4, as shown in FIG. 1a, should have the form and function of conventional pumps of adequate design and capacity to handle the specified secondary working fluid in an efficient manner to and from conduits/tubulars/exchanger, as shown in FIGS. 2-5, and from thermal hydraulic engine 1.2 and condenser 1.5, as shown in FIG. 1a. In an alternative embodiment, secondary working fluid pump 1.4 could be replaced by a natural thermally convecting thermo-siphon, wherein secondary working fluid in the cooler condensed state returns from condenser 1.5 in conduits/tubulars/exchangers extending down hole 1.1, and becomes heated from formation 1.10, attenuating toward expansion from reaching its critical temperature and rising from the lower portion of hole 1.1 and returning via upwardly extending conduits/tubulars/exchangers into thermal hydraulic engine 1.2.

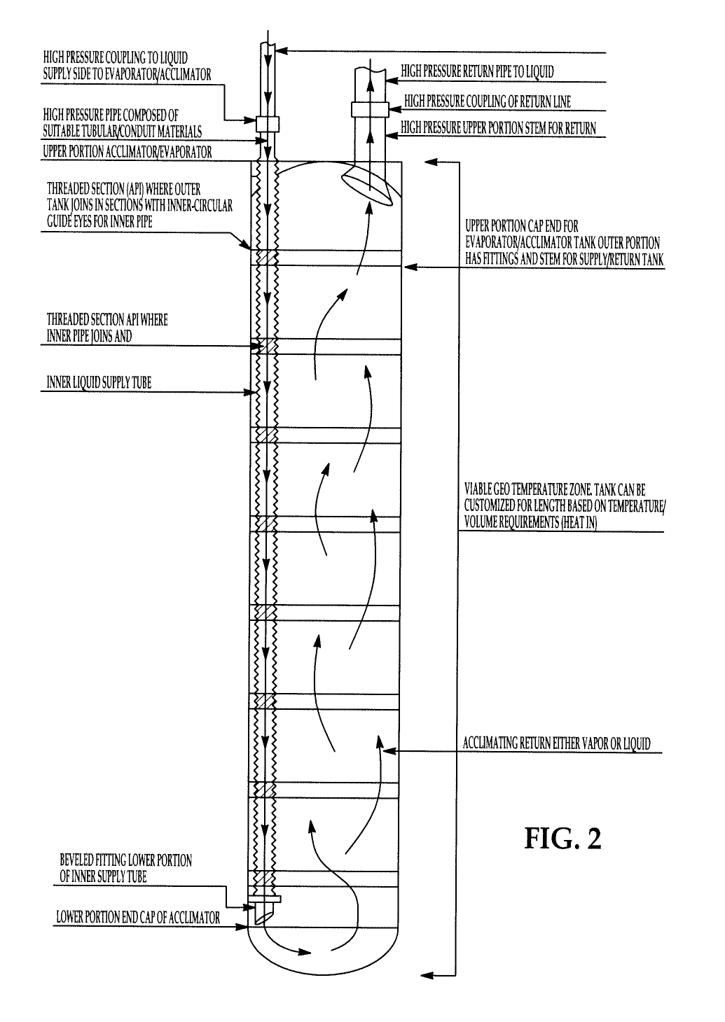

The main components and the related subcomponents of one embodiment of the present invention along with their interconnections would be considered novel by one skilled in art in that it results in a usable output of power generation via hole 1.1 reclamation and/or slab construction for waste heat applications. Hole 1.1 could be of any resulting drilling operation via specific or collateral. Hole 1.1 must contain lower portion temperatures adequate enough to bring specified secondary working fluid 1.8 to its supercritical temperature of which is preferably CO₂ and temperature greater than 60° F., but preferably greater than 160° F. Hole 1.1 is connected to and part of the interfacing formation of which hole 1.1 is located within thermally conditioned backfill material, as shown in FIG. 2. The thermally conditioned backfill material is utilized to fill the annulus of hole 1.1 either cased or uncased, and extends downward to and from the lower and upper portions with conduits/tubulars/exchangers, as depicted in FIGS. 1-5. The conduits/tubulars/exchangers and the associated cementing conduit are simultaneously lowered into hole 1.1 via spooling and cementing equipment for the purpose of pumping thermally conditioned backfill material in and around the downwardly extending conduits/tubulars/exchangers and filling the annulus of hole 1.1. The thermally conditioned backfill material commences pumping when the conduits/tubulars/exchangers are in a final orientation within hole 1.1. The cementing conduit is removed as pumping commences. Once completed and set, the upper portion of conduits/tubulars/exchangers are connected via hydraulic pressure fittings to thermal hydraulic engine 1.2 on the return side of the secondary working fluid conduits as shown in FIG. 3. The thermal hydraulic engine is connected via turning output shaft 1.9 to power generation equipment 1.3. Secondary working fluid 1.8, preferably CO2, will put the thermal hydraulic engine's expander under supercritical state and expand to high pressure gas, operating thermal hydraulic engine 1.2 and associated connections via output shaft 1.9 to power generation equipment 1.3 for a preferred usable electric output of a plurality of kWs. From the output side of thermal hydraulic engine expander 1.2, secondary working fluid 1.8 will flow through necessary conduits into condenser 1.5 where said secondary working fluid 1.8 will be acted on by cooling fluid 1.7, which is connected via its necessary conduits to cooling tower 1.6, where heat is transferred to the atmosphere, to bring secondary working fluid 1.8 back below supercritical temperatures into its liquid phase. Secondary working fluid 1.8 will be drawn by secondary working fluid pump 1.4 from condenser 1.5 through conduits and pumped under pressure back down the supply side of secondary working fluid conduits, as shown in FIG. 3, extending from the upper portion of hole 1.1 downward into the lower portion of hole 1.1, where heat from formation 1.10 acts on secondary working fluid 1.8 via convective heat exchange. Thus, secondary working fluid is brought inside of conduits back to super critical saturation temperatures, and the cycle begins again.

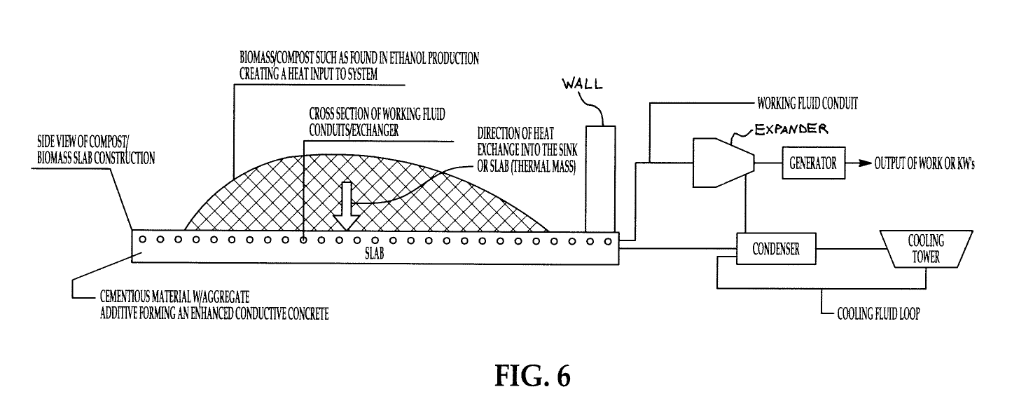

Another embodiment of the present invention utilizes any waste heat source in the manner described previously by utilizing secondary working fluid conduits/tubulars/exchangers in an appropriate configuration on any waste heat source in a plurality of designs similar to embodiments of the present invention, such as that disclosed in FIG. 6.

As to a further discussion of the manner of usage and operation of the present invention, the same should be apparent from the above description.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An apparatus for using a hole to generate power via geo-saturation of secondary working fluids, said apparatus comprising:
a plurality of conduits, wherein said conduits extend from the upper to the lower portion of said hole;
a thermal hydraulic engine located at the upper portion of said hole, wherein said thermal hydraulic engine is connected on a first end to said conduits, and on a second end to power generation equipment;
organic compound secondary working fluid capable of low critical temperatures greater than 60° F. in the liquid phase;
thermally conditioned fill material located in the lower portion and along the length and width of said hole;
an exchanger containing said conduits;
a cooling apparatus; and
a fluid pump.
